(19) United States
(12) Patent Application Publication
(10) Pub. No.: US 2015/0214540 A1
(43) Pub. Date: Jul. 30, 2015

(54) POSITIVE ACTIVE MATERIAL, LITHIUM BATTERY INCLUDING THE SAME, AND METHOD OF MANUFACTURING THE POSITIVE ACTIVE MATERIAL

(71) Applicant: SAMSUNG SDI CO., LTD., Yongin-si (KR)

(72) Inventors: Young-Ki Kim, Yongin-si (KR); Young-Hun Lee, Yongin-si (KR); Soon-Rewl Lee, Yongin-si (KR); Ick-Kyu Choi, Yongin-si (KR); Yong-Chul Park, Yongin-si (KR)

(21) Appl. No.: 14/538,682

(22) Filed: Nov. 11, 2014

(30) Foreign Application Priority Data
Jan. 27, 2014 (KR) 10-2014-0009936

(51) Int. Cl. H01M 4/36; H01M 10/052; H01M 4/485

(52) U.S. Cl. CPC H01M 4/364; H01M 4/485; H01M 4/366; H01M 10/052

(57) ABSTRACT

A positive active material, a lithium battery including the same, and a method of manufacturing the positive active material. The positive active material includes lithium-transition metal composite oxide and lithium titanium molybdate. Here, the lithium titanium molybdate functions as a sacrificial positive electrode. The positive active material may increase charge capacity of the lithium battery and may improve lifetime characteristics of the lithium battery.

### CROSS-REFERENCE TO RELATED APPLICATION

This application claims priority to and the benefit of Korean Patent Application No. 10-2014-0009936, filed on Jan. 27, 2014, in the Korean Intellectual Property Office, the disclosure of which is incorporated herein in its entirety by reference.

### BACKGROUND

1. Field

One or more embodiments relate to a positive active material, a lithium battery including the same, and a method of manufacturing the positive active material.

2. Description of the Related Art

Recently, lithium secondary batteries have drawn significant attention as power sources for small portable electronic devices. Lithium batteries that use (utilize) an organic electrolytic solution have a discharge voltage about twice as high as those using (utilizing) an aqueous alkali solution as an electrolyte, thereby having high energy density.

Lithium secondary batteries use (utilize) a material that enables intercalation and deintercalation of lithium ions in a positive electrode and a negative electrode. The lithium secondary batteries are manufactured by interposing an organic electrolytic solution or a polymer electrolytic solution between the positive electrode and the negative electrode, and generate electric energy by oxidation and reduction reactions when lithium ions are intercalated into and deintercalated from the positive electrode and the negative electrode.

LiCoO₂ has been widely used (utilized) as a positive active material for lithium secondary batteries. However, manufacturing costs of LiCoO₂ increase and a stable supply thereof is not guaranteed. Thus, a positive active material has been developed using (utilizing) a composite material of nickel and manganese as a material capable of replacing LiCoO₂.

In the case of nickel-based composite oxides, the capacity per unit volume may be increased by increasing the amount of nickel or increasing the density of a mixture of the positive active material. However, there is still a need to develop a positive active material having high packing density, excellent thermal stability, and high capacity.

### SUMMARY

An aspect according to one or more embodiments of the present invention is directed toward a positive active material having high capacity and long lifetime.

An aspect according to one or more embodiments of the present invention is directed toward a lithium battery including the positive active material.

An aspect according to one or more embodiments of the present invention is directed toward a method of manufacturing the positive active material.

Additional aspects will be set forth in part in the description which follows and, in part, will be apparent from the description, or may be learned by practice of the presented embodiments.

According to one or more embodiments, a positive active material includes a lithium-transition metal composite oxide, and lithium titanium molybdate represented by Formula 1 below:

LiₐMo₁₋ₓTiₓO_{b} Formula 1

In Formula 1, 0.1≦a≦2.3, 0<x≦0.3, and 2.8≦b≦3.2.

The lithium titanium molybdate may be a sacrificial positive electrode. The lithium titanium molybdate may be in an amorphous MoO₃form after a formation process.

In one embodiment, 2.1≦a≦2.3. In one embodiment, 0.1≦x≦0.3.

The lithium titanium molybdate may include, on the surface thereof, a metal compound-containing coating layer including at least one element selected from the group consisting of sodium (Na), potassium (K), cesium (Cs), magnesium (Mg), calcium (Ca), strontium (Sr), barium (Ba), yttrium (Y), lanthanum (La), titanium (Ti), zirconium (Zr), vanadium (V), manganese (Mn), iron (Fe), cobalt (Co), nickel (Ni), silver (Ag), gold (Au), zinc (Zn), and aluminum (Al).

The metal compound may include a metal oxide, a Li-containing metal oxide, a metal alkoxide, or any combination thereof.

The lithium titanium molybdate may exhibit a first peak at a diffraction angle 2θ of 18.00±0.05° as a result of X-ray diffraction analysis using (utilizing) CuKα rays.

The lithium-transition metal composite oxide may include at least one compound selected from the group consisting of LiCoO₂; LiNiO₂; LiMnO₂; LiMn₂O₄; Li(Niₐ₁Co_{b1}Mn_{c1})O₂, where 0<a1<1, 0<b1<1, 0<c1 <1, and a1+b1+c1=1; LiNi_{1-Y}CO_{Y}O₂, LiICo_{1-Y}Mn_{Y}O₂, LiNi_{1-Y}Mn_{Y}O₂, where 0≦Y<1; Li(Niₐ₂Co_{b2}Mn_{c2})O₄, where 0<a2<2, 0<b2<2, 0<c2<2, and a2+b2+c2=2; LiMn_{2-z}Ni_{z}O₄, LiMn_{2-z}Co_{z}O₄, where 0<Z<2; LiCoPO₄; LiFePO₄; LiFePO₄; V₂O₅; TiS; and MoS.

A weight ratio of the lithium-transition metal composite oxide to the lithium titanium molybdate may be about 50:50 to about 99:1.

According to one or more embodiments, a positive active material includes lithium titanium molybdate exhibiting a first peak at a diffraction angle 2θ of 18.00±0.05° as a result of X-ray diffraction analysis using (utilizing) CuKα rays.

The lithium titanium molybdate may exhibit a second peak at a diffraction angle 2θ of 43.6±0.1° as a result of X-ray diffraction analysis using (utilizing) CuKα, and a peak intensity ratio of the first peak to the second peak I₁/I₂ may be about 1.2 to about 2.5.

The lithium titanium molybdate may be represented by Formula 1 below:

LiₐMo₁₋ₓTiₓO_{b} Formula 1

wherein 0.1≦a≦2.3, 0<x≦0.3, and 2.8≦b≦3.2.

According to one or more embodiments, a lithium battery includes a positive electrode including the positive active material, a negative electrode facing the positive electrode, and an electrolyte between the positive electrode and the negative electrode.

The negative electrode may include a material selected from the group consisting of Si, SiOₓ (0<x<2), an Si—Y alloy (where Y is an alkali metal, an alkali earth metal, a Group XIII element, a Group XIV element except for Si, a transition metal, a rare earth element, or any combination thereof), and combinations thereof.

According to one or more embodiments, a method of manufacturing a positive active material includes: performing a first heat-treatment of a first mixture including a lithium source, a molybdenum source, and a titanium source at a temperature of about 600 to about 1300° C. in a reducing atmosphere; preparing a second mixture by adding a metal element (M) source to be coated on a product of the first heat-treatment; and preparing lithium titanium molybdate represented by Formula 1 below by performing a second heat-treatment of the second mixture at a temperature of about 700 to about 1200° C. in a reducing atmosphere:

LiₐMo₁₋ₓTiₓO_{b} Formula 1

wherein 0.1≦a≦2.3, 0<x≦0.3, and 2.8≦b≦3.2.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic diagram of a structure of a lithium battery according to an embodiment;

FIG. 2 is a graph illustrating X-ray diffraction (XRD) analysis results of lithium titanium molybdate prepared according to Preparation Example 4;

FIG. 3 is a scanning electron microscopic (SEM) image of lithium molybdate prepared according to Comparative Preparation Example 1;

FIG. 4 is an SEM image of lithium titanium molybdate prepared according to Preparation Example 1;

FIG. 5 is a graph illustrating charge capacity of lithium batteries manufactured according to Examples 1 to 6 and Comparative Examples 1 to 3;

FIG. 6 is a graph illustrating capacity retention ratios of lithium batteries manufactured according to Examples 1 to 6 and Comparative Examples 1 to 3; and

FIGS. 7A and 7B are graphs illustrating X-ray diffraction (XRD) analysis results of samples of positive electrode plates of lithium batteries manufactured according to Example 4 and Comparative Example 3 after charging.

### DETAILED DESCRIPTION

Reference will now be made in more detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list. Further, the use of “may” when describing embodiments of the present invention refers to “one or more embodiments of the present invention.”

A positive active material according to an embodiment includes a lithium-transition metal composite oxide and lithium titanium molybdate represented by Formula 1 below.

LiₐMo₁₋ₓTiₓO_{b} Formula 1

In Formula 1, 0.1≦a≦2.3, 0<x≦0.3, and 2.8≦b≦3.2.

The lithium titanium molybdate is a lithium molybdenum oxide in which some of molybdenum (Mo) are substituted with titanium (Ti), and may be used (utilized) as a sacrificial positive electrode during charging and discharging of a lithium battery. Here, the “sacrificial positive electrode” may be defined as follows. Lithium ions of a positive active material migrate from a positive electrode to a negative electrode via an electrolyte and may be stored in a layered structure of a negative active material during charging of a lithium battery, and the lithium ions migrate from the negative electrode to the positive electrode via the electrolyte during discharging. In this case, some of the lithium ions discharged from the positive electrode remain in the layered structure of the negative active material. Accordingly, not all of the lithium ions can return to the positive electrode. As such, the amount of lithium ions remaining in the negative electrode may result in capacity reduction. To compensate for this, the positive active material is additionally added thereto. The additionally added positive active material is regarded as a sacrificial positive electrode. In general, an active material that is the same as or different from the positive active material used (utilized) in the positive electrode may further be used (utilized) as the sacrificial positive electrode.

In the positive active material, the lithium titanium molybdate may function as the sacrificial positive electrode so that the lithium titanium molybdate may have influence on electrochemical properties only during a formation process and exist in an amorphous MoO₃ form after the formation process. When applied to a battery, the lithium titanium molybdate has a capacity of about 250 mAh/g or greater, which is greater than capacities of comparable positive active materials such as lithium-cobalt oxide (LCO)-based, lithium-manganese oxide (LMO)-based, nickel-cobalt-manganese (NCM)-based, nickel-cobalt-aluminum (NCA)-based, or lithium-iron-phosphate (LiFePO₄)-based positive active materials. The lithium titanium molybdate compensates for the irreversible capacity drop of the negative electrode during the formation process. As a result, capacity of the battery increases by the same amount as the increased charge capacity of the positive active material.

The lithium titanium molybdate may be represented by Formula 1, and 0.1≦a≦2.3 in Formula 1. The value of a may be determined within a range sufficient for discharging lithium ions during the formation process according to the kind of the negative electrode material, more particularly, charge capacity of the negative electrode. For example, the value of a may satisfy 2.05≦a≦2.3, 2.1≦a≦2.3, or 2.15≦a≦2.2.

In Formula 1, the value of x, as an amount of the substituent Ti, may satisfy 0<x≦0.3. By substituting at least some of Mo with Ti, binding force between Mo and oxygen and between Ti and oxygen may be increased. Elution of Mo may be reduced or prevented by maintaining the positive active material at high temperature. However, when x is greater than 0.3, the lithium titanium molybdate may have an unstable crystal structure. According to an embodiment, 0.1≦x≦0.3, for example, 0.05≦≦0.3.

In Formula 1, the value of b refers to a stoichiometric ratio (amount) of oxygen and may vary according to manufacturing environment for the lithium titanium molybdate. For example, 2.8≦b≦3.2. For example, b may be about 3.

The lithium titanium molybdate may further include a coating layer on the surface thereof. The coating layer may include a metal compound including at least one metal element (M) selected from sodium (Na), potassium (K), cesium (Cs), magnesium (Mg), calcium (Ca), strontium (Sr), barium (Ba), yttrium (Y), lanthanum (La), titanium (Ti), zirconium (Zr), vanadium (V), manganese (Mn), iron (Fe), cobalt (Co), nickel (Ni), silver (Ag), gold (Au), zinc (Zn), and aluminum (Al). Here, the coating layer does not include Mo.

The metal compound may include a metal oxide, a Li-containing metal oxide, a metal alkoxide, or any combination thereof. The metal compound may be a Li-containing metal oxide. For example, the metal compound may include a lithium-titanium oxide. The coating layer formed on the surface of the lithium titanium molybdate may be crystalline or amorphous.

The lithium titanium molybdate having this structure has a different crystal structure from that of comparable lithium molybdenum oxide, and the difference of the crystal structure may be identified by using (utilizing) X-ray diffraction patterns. For example, the lithium titanium molybdate may exhibit a first peak at a diffraction angle 2θ of about 18.00±0.05° as a result of X-ray diffraction analysis using (utilizing) CuKα rays. The lithium titanium molybdate is different from comparable lithium molybdenum oxide which exhibits a first peak at a diffraction angle 2θ of about 17.90°.

In addition, the lithium titanium molybdate may exhibit a second peak at a diffraction angle 2ν of about 43.6±0.1°. Here, a peak intensity ratio of the first peak to the second peak I₁/I₂ may be about 1.20 to about 2.5.

According to an embodiment, the lithium titanium molybdate may have an average particle diameter of about 2 to about 10 μm.

Meanwhile, any other lithium-transition metal composite oxides commonly used (utilized) in positive active materials may be applied to embodiments without limitation. For example, the lithium-transition metal composite oxide may include at least one compound that allows intercalation and deintercalation of lithium ions such as LiCoO₂, LiNiO₂, LiMnO₂, LiMn₂O₄, Li(Niₐ₁Co_{b1}Mn_{c1})O₂ (0<a1<1, 0<b1<1, 0<c1<1, and a1+b1+c1=1), LiNi_{1-Y}Co_{Y}O₂, LiCo_{1-Y}Mn_{Y}O₂, LiNi_{1-y}Mn_{Y}O₂ (0≦Y<1), Li(Niₐ₂Co_{b2}Mn_{c2})O₄, (0<a2<2, 0<b2<2, 0<c2<2, and a2+b2+c2=2), LiMn_{2-z}Ni_{z}O₄, LiMn_{2-z}Co_{z}O₄ (0<Z<2), LiCoPO₄, LiFePO₄, V₂O₅, TiS, or MoS. According to an embodiment, the lithium-transition metal composite oxide may be LiCoO₂.

According to an embodiment, the amount of the lithium-transition metal composite oxide and the amount of the lithium titanium molybdate are not particularly limited, and may be determined appropriately such that desirable electrochemical characteristics may be obtained without having a reduced charge capacity. For example, the lithium-transition metal composite oxide and the lithium titanium molybdate may be mixed in a weight ratio of about 50:50 to about 99:1. In one embodiment, the weight ratio of the lithium-transition metal composite oxide to the lithium titanium molybdate may be about 97.5:2.5 to about 70:30, for example, about 95:5 to about 80:20.

According to another embodiment, provided is a positive active material including lithium titanium molybdate exhibiting a first peak at a diffraction angle 2θ of about 18.00±0.05° as a result of X-ray diffraction analysis using (utilizing) CuKα rays.

The lithium titanium molybdate may function as a sacrificial positive electrode during charging and discharging of the lithium battery. The sacrificial positive electrode is as described above, and thus detailed descriptions thereof will not be given herein.

The lithium titanium molybdate exhibits a second peak at a diffraction angle 2θ of about 43.6±0.1° as a result of X-ray diffraction analysis using (utilizing) CuKα rays. A peak intensity ratio of the first peak to the second peak I₁/I₂ may be about 1.2 to about 2.5.

The lithium titanium molybdate may be represented by Formula 1 below.

LiₐMo₁₋ₓTiₓO_{b} Formula 1

In Formula 1, 0.1≦a≦2.3, 0<x≦0.3, and 2.8≦b≦3.2.

In addition, the lithium titanium molybdate may further include, on the surface thereof, a coating layer that includes a metal compound including at least one element selected from sodium (Na), potassium (K), cesium (Cs), magnesium (Mg), calcium (Ca), strontium (Sr), barium (Ba), yttrium (Y), lanthanum (La), titanium (Ti), zirconium (Zr), vanadium (V), manganese (Mn), iron (Fe), cobalt (Co), nickel (Ni), silver (Ag), gold (Au), zinc (Zn), and aluminum (Al). Here, the metal compound may include a metal oxide, a Li-containing metal oxide, a metal alkoxide, or any combination thereof. For example, the metal compound may include a Li-containing metal oxide.

The lithium titanium molybdate may have an average particle diameter of about 2 to about 10 μm.

The positive active material may further include any suitable lithium-transition metal composite oxide commonly used (utilized) in the art together with the lithium titanium molybdate. The lithium-transition metal composite oxide may be any suitable compound that allows intercalation and deintercalation of lithium ions without limitation. For example, the lithium-transition metal composite oxide may be LiCoO₂, LiNiO₂, LiMnO₂, LiMn₂O₄, Li(Niₐ₁Co_{b1}Mn_{c1})O₂ (0<a1<1, 0<b1<1, 0<c1<1, and a1+b1+c1=1), LiNi_{1-Y}Co_{Y}O₂, LiCo_{1-Y}Mn_{Y}O₂, LiNi_{1-Y}Mn_{Y}O₂(0≦Y<1), Li(Niₐ₂Co_{b2}Mn_{c2})O₄ (0<a2<2, 0<b2<2, 0<c2<2, and a2+b2+c2=2), LiMn_{2-z}Ni_{z}O₄, LiMn_{2-z}Co_{z}O₄ (0<Z<2), LiCoPO₄, or LiFePO₄, alone (singularly) or any combination of at least two thereof. For example, the lithium-transition metal composite oxide may be LiCoO₂.

The lithium-transition metal composite oxide and the lithium titanium molybdate may be used (utilized) in a weight ratio of about 50:50 to about 99:1.

The positive active material according to an embodiment as described above may be prepared according to various suitable processes. For example, the lithium titanium molybdate may be prepared by using (utilizing) various suitable methods such as solid state reaction, a sol-gel method, calcining, or a co-precipitation method. The positive active material may be prepared by mixing the lithium titanium molybdate and the lithium-transition metal composite oxide in a desired ratio.

For example, the lithium titanium molybdate may be prepared by solid state reaction. First, a lithium source, a molybdenum source, and a titanium source are mixed in a desired ratio as reactants, and the mixture is subjected to a first heat-treatment at a temperature of about 600 to about 1300° C. in a reducing atmosphere. Then, a metal element (M) source, as a coating material, is mixed with a product of the first heat-treatment, and the mixture is subjected to a second heat-treatment at a temperature of about 700 to about 1200° C. in a reducing atmosphere to prepare lithium titanium molybdate coated with the metal compound.

In the preparation method, the lithium source may include lithium carbonate, lithium nitrate, lithium oxide, lithium hydroxide, lithium halide, and/or the like without being limited thereto. The molybdenum source may include molybdenum oxide, molybdenum nitride, molybdenum carbonate, molybdenum halide, molybdenum sulfide, and/or the like, without being limited thereto. The titanium source may include titanium oxide, titanium nitride, titanium tetrachloride, and/or the like without being limited thereto.

The lithium source, the molybdenum source, and the titanium source used (utilized) in the first heat-treatment may respectively be used (utilized) in sufficient amounts to prepare LiₐMo₁₋ₓTiₓO_{b} of Formula 1. For example, when Li₂CO₃, MoO₃, and TiO₂ are respectively used (utilized) as the lithium source, the molybdenum source, and the titanium source, an amount of Li₂CO₃ may be about 1 to about 1.1 mol based on 1 mol of a total amount of MoO₃ and TiO₂.

The first heat-treatment may be performed while heating within a temperature range of about 600 to about 1300° C. Here, the heating may be performed by consecutively (continuously) or stepwise increasing the temperature. For example, the first heat-treatment may be performed as a multiple-stage process, for example, as a two-stage process, by stepwise increasing the temperature. For example, the first heat-treatment may include a first heat-treatment stage at about 600 to about 800° C. in a reducing atmosphere, and a second heat-treatment stage at about 1000 to about 1150° C. in a reducing atmosphere.

The first heat-treatment may be performed in a reducing atmosphere to facilitate the phase formation. Although the first heat-treatment time may vary according to the heating process and heat-treatment temperature, the first heat-treatment may be performed within a range of about 10 to about 30 hours. Accordingly, the crystal structure of lithium titanium molybdate represented by Formula 1 may be obtained.

The second heat-treatment is a process to form a coating layer of a metal compound on the surface of the lithium titanium molybdate prepared in the first heat-treatment. The metal compound may include at least one metal element (M) selected from sodium (Na), potassium (K), cesium (Cs), magnesium (Mg), calcium (Ca), strontium (Sr), barium (Ba), yttrium (Y), lanthanum (La), titanium (Ti), zirconium (Zr), vanadium (V), manganese (Mn), iron (Fe), cobalt (Co), nickel (Ni), silver (Ag), gold (Au), zinc (Zn), and aluminum (Al). Sources of the metal element (M) to be coated may be carbonate, nitrate, and/or oxide of the metal element.

The second heat-treatment may be performed at a temperature of 700 to 1200° C. in a reducing atmosphere, but does not include a heating process differently from the first heat-treatment. Although the heat-treatment time may vary according to the heat-treatment temperature, the second heat-treatment may be performed within a range of about 2 to about 15 hours.

The prepared lithium titanium molybdate, which is used (utilized) as a sacrificial positive electrode, may be mixed with the lithium-transition metal composite oxide in a desired ratio to complete the preparation of the positive active material.

A lithium battery according to another embodiment includes: a positive electrode including the positive active material; a negative electrode disposed opposite to the positive electrode; and an electrolyte interposed between the positive electrode and the negative electrode.

The positive electrode includes the positive active material and may be manufactured, for example, by preparing a positive active material composition by mixing the positive active material, a conductive agent, and a binder in a solvent, and then molding the positive active material composition to a certain shape, or coating the positive active material composition on a current collector, such as copper foil.

In addition, the conductive agent that is used (utilized) to form the positive active material composition provides a conductive passage to the positive active material to improve the electrical conductivity, and may be any suitable conductive agent commonly used (utilized) in lithium batteries. Examples of the conductive agent are: a carbonaceous material such as carbon black, acetylene black, ketjen black, or carbon fiber (for example, a vapor phase growth carbon fiber); a metal such as copper, nickel, aluminum, or silver, each of which may be used (utilized) in powder or fiber form; a conductive polymer such as a polyphenylene derivative; and any mixture thereof. An amount of the conductive agent may be appropriately controlled. For example, the conductive agent may be added thereto in such an amount that a weight ratio of the positive active material to the conductive agent is in a range of about 99:1 to about 90:10.

The binder used (utilized) in the positive active material composition facilitates binding between the positive active material and the conducting agent, and binding to the current collector. The amount of the binder may be about 1 to about 50 parts by weight based on 100 parts by weight of the positive active material. For example, the amount of the binder may be about 1 to about 30 parts by weight, for example, about 1 to about 20 parts by weight, or about 1 to about 15 parts by weight, based on 100 parts by weight of the positive active material. Examples of the binder may include polyvinylidenefluoride, polyvinylidenechloride, polybenzimidazole, polyimide, polyvinylacetate, polyacrylonitrile, polyvinyl alcohol, carboxymethylcellulose (CMC), starch, hydroxypropylcellulose, regenerated cellulose, polyvinylpyrrolidone, tetrafluoroethylene, polyethylene, polypropylene, polystyrene, polymethylmethacrylate, polyaniline, acrylonitrilebutadienestyrene, phenol resin, epoxy resin, polyethyleneterephthalate, polytetrafluoroethylene, polyphenylsulfide, polyamideimide, polyetherimide, polyethylenesulfone, polyamide, polyacetal, polyphenyleneoxide, polybutylenetelephthalate, ethylene-propylene-diene terpolymer (EPDM), sulfonated EPDM, styrene butadiene rubber, a fluoride rubber, and various suitable copolymers.

Examples of the solvent include N-methylpyrrolidone (NMP), acetone, water, and the like. An amount of the solvent may be in a range of about 1 to about 10 parts by weight based on 100 parts by weight of the positive active material. When the amount of the solvent is within this range, a process for forming the active material layer may be efficiently performed.

In addition, the current collector is generally fabricated to have a thickness of about 3 to about 500 μm. The current collector is not particularly limited, and may be any materials so long as it has a suitable conductivity without causing chemical changes in the fabricated battery. Examples of the current collector include copper, stainless steel, aluminum, nickel, titanium, calcined carbon, copper or stainless steel that is surface-treated with carbon, nickel, titanium or silver, and aluminum-cadmium alloys. In addition, the current collector may be processed to have fine irregularities on the surface thereof so as to enhance adhesive strength of the current collector to the positive active material, and may be used (utilized) in any of various suitable forms including films, sheets, foils, nets, porous structures, foams, and non-woven fabrics.

The prepared positive active material composition may be coated directly on the current collector to manufacture a positive electrode plate. Alternatively, the positive electrode plate may be manufactured by casting the positive active material composition on a separate support to form a positive active material film, separating the positive active material film from the support, and laminating the positive active material film on a copper foil current collector. The positive electrode is not limited to these examples described above, and may be one of a variety of suitable positive electrodes.

The positive active material composition is not only used (utilized) in the preparation of the electrode of lithium batteries, but also used (utilized) in the preparation of a printable battery by being printed on a flexible electrode substrate.

Separately, for the manufacture of a negative electrode, a negative active material composition is prepared by mixing a negative active material, a binder, a solvent, and optionally a conductive agent.

The negative active material may be any suitable negative active material commonly used (utilized) in the art without limitation. The negative active material may include lithium metal, a metal that is alloyable with lithium, a transition metal oxide, and a material that allows doping or undoping of lithium, and a material that allows reversible intercalation and deintercalation of lithium ions, without being limited thereto.

Examples of the transition metal oxide include a tungsten oxide, a molybdenum oxide, a titanium oxide, a lithium titanium oxide, a vanadium oxide, and a lithium vanadium oxide, without being limited thereto.

The material that allows doping or undoping of lithium may be, for example Si, SiOₓ (0<x<2), an Si—Y alloy (where Y is an alkali metal, an alkali earth metal, a Group XIII element, a Group XIV element except for Si, a transition metal, a rare earth element, or any combination thereof), Sn, SnO₂, an Sn—Y alloy (where Y is an alkali metal, an alkali earth metal, a Group XIII element, a Group XIV element except for Sn, a transition metal, a rare earth element, or any combination thereof), where at least one of these materials may be used (utilized) in combination with SiO₂. Here, Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or any combination thereof.

The material that allows reversible intercalation and deintercalation of lithium ions may be any suitable carbonaceous material that is a carbonaceous negative active material commonly used (utilized) in lithium batteries. Examples of such carbonaceous materials may include crystalline carbon, amorphous carbon, or mixtures thereof. The crystalline carbon may include natural graphite or artificial graphite that are in amorphous, plate, flake, spherical or fibrous form, without being limited thereto. The amorphous carbon may include soft carbon (cold calcined carbon), hard carbon, mesophase pitch carbide, and calcined cork, without being limited thereto.

According to an embodiment, the negative active material may be a silicon-based negative active material such as Si, SiOₓ (0<x≦2), or a Si—Y alloy alone (singularly) or any combination of at least two thereof. The silicon-based negative active material has high capacity and high irreversible capacity. Thus, when a positive electrode is prepared using (utilizing) the lithium titanium molybdate as a sacrificial electrode, a total capacity may be improved.

The conductive agent, the binder, and the solvent used (utilized) in the negative active material composition may be the same or different from those of the positive active material composition described above. If desired, a plasticizer may further be added to the positive active material composition and the negative active material composition to form pores inside the electrode plates. Here, the amounts of the negative active material, the conductive material, the binder, and the solvent may be the same level as those suitably used (utilized) in lithium batteries.

The negative current collector may be any one of various suitable current collectors that has a thickness ranging from about 3 to about 500 μm, does not cause any chemical change in the fabricated battery, and has high conductivity. For example, stainless steel, aluminum, nickel, titanium, calcined carbon, and aluminum or stainless steel that is surface-treated with carbon, nickel, titanium, silver, or the like may be used (utilized). The current collector may have a surface on which fine irregularities are formed to enhance adhesive strength of the current collector to a negative active material. The current collector may be used (utilized) in any of various suitable forms including films, sheets, foils, nets, porous structures, foams, and non-woven fabrics.

The prepared negative active material composition may be coated directly on the negative current collector and dried to prepare a negative electrode plate. Alternatively, the negative active material composition may be cast on a separate support, and then a film separated from the support is laminated on the negative current collector to prepare a negative electrode plate.

The positive electrode and the negative electrode may be separated from each other by a separator. Any suitable separator that is commonly used (utilized) in lithium batteries may be used (utilized). Particularly, a separator that has low resistance to migration of ions of an electrolyte and excellent electrolytic solution-retaining ability may be used (utilized). Examples of the separator may include glass fiber, polyester, Teflon®, polyethylene, polypropylene, polytetrafluoroethylene (PTFE), and a combination thereof, each of which may be a nonwoven fabric or a woven fabric. The separator has a pore diameter of about 0.01 to about 10 μm and a thickness of about 5 to about 300 μm.

A lithium salt-containing non-aqueous electrolyte includes a non-aqueous electrolyte solution and a lithium salt. As the non-aqueous electrolyte, a non-aqueous electrolyte solution, an organic solid electrolyte, or an inorganic solid electrolyte may be used (utilized).

Examples of the non-aqueous electrolyte solution may include any suitable aprotic organic solvent such as N-methyl-2-pyrrolidone, propylene carbonate, ethylene carbonate, butylene carbonate, dimethyl carbonate, diethyl carbonate, gamma-butyro lactone, 1,2-dimethoxy ethane, tetrahydrofuran, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, and ethyl propionate.

Examples of the organic solid electrolyte may include polyethylene derivatives, polyethylene oxide derivatives, polypropylene oxide derivatives, phosphoric acid ester polymers, poly agitation lysine, polyester sulfide, polyvinyl alcohol, polyvinylidene fluoride, and polymers containing ionic dissociation groups.

Examples of the inorganic solid electrolyte may include a nitride, halide, or sulfate of Li such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

Any suitable lithium salt commonly used (utilized) in lithium batteries may be used (utilized). The lithium salt is a material that is readily soluble in the non-aqueous electrolyte and may include at least one selected from LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, chloroborate lithium, lower aliphatic carboxylic acid lithium, lithium tetraphenyl borate, and imide.

Lithium batteries may be classified into lithium ion batteries, lithium ion polymer batteries, and lithium polymer batteries according to the kinds of separator and electrolyte. In addition, lithium batteries may be classified into a cylindrical battery, a rectangular battery, a coin battery, or a pouch battery according to the shape of the battery, and may be classified into a bulk battery or a thin film battery according to the size of the battery. Lithium batteries may be used (utilized) either as lithium primary batteries or lithium secondary batteries.

Methods of manufacturing these batteries are known in the field, and detailed descriptions thereof will not be repeated.

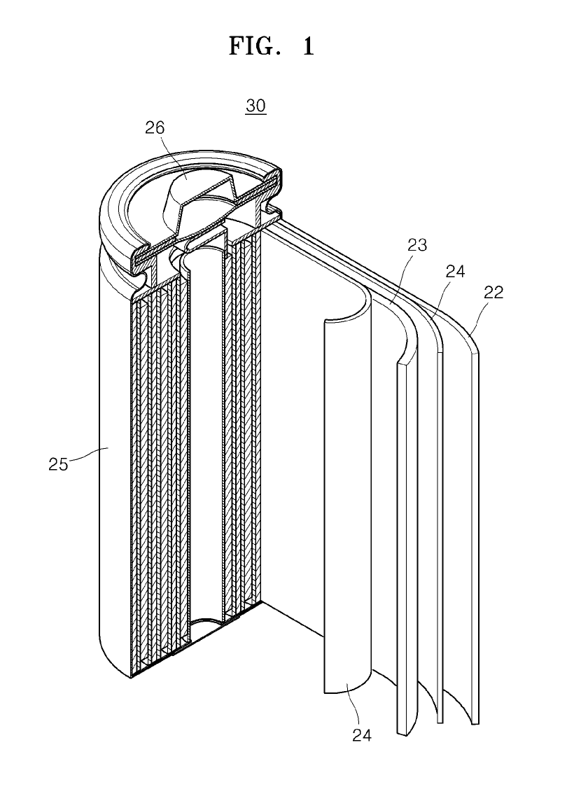

FIG. 1 is a schematic diagram of a structure of a lithium battery 30 according to an embodiment.

Referring to FIG. 1, the lithium battery 30 includes a positive electrode 23, a negative electrode 22, and a separator 24 disposed between the positive electrode 23 and the negative electrode 22. The positive electrode 23, the negative electrode 22, and the separator 24 are wound or folded, and then accommodated in a battery case 25. Then, an electrolyte is injected into the battery case 25, and the battery case 25 is sealed by a sealing member 26, thereby completing the manufacture of the lithium battery 30. The battery case 25 may have a cylindrical shape, a rectangular shape, or a thin-film shape. The lithium battery may be a lithium ion battery.

The lithium battery may be suitable for use as power sources for electric vehicles requiring high capacity, high-power output, and high temperature conditions for operations, in addition to power sources for conventional mobile phones and portable computers, and may be coupled to conventional internal combustion engines, fuel cells, or super-capacitors to be used (utilized) in hybrid vehicles. In addition, the lithium battery may be used (utilized) in all applications requiring high-power output, high voltage, and high temperature conditions for operations.

One or more embodiments will be described in more detail with reference to the following examples. However, these examples are not intended to limit the scope of the one or more embodiments.

### Preparation of Lithium Titanium Molybdate

### Preparation Example 1

Li₂CO₃, MoO₃, and TiO₂ were mixed as starting materials in a molar ratio of 2.05:0.8:0.2 in metal powder forms. The mixture was heat-treated at 700° C. in a reducing atmosphere for 10 hours and cooled to obtain Li_{2.05}Mo_{0.8}Ti_{0.2}O₃. Then, the prepared Li_{2.05}Mo_{0.8}Ti_{0.2}O₃ was heat-treated at 1100° C. in a reducing atmosphere for 10 hours. Then, an ethanol solution of 0.3 wt % Ti-isopropoxide was coated on the heat-treated Li_{2.05}Mo_{0.8}Ti_{0.2}O₃, and the resultant was heat-treated at 900° C. in a reducing atmosphere for 10 hours to prepare lithium titanium molybdate having a core-shell structure and coated with Li—Ti—O.

### Preparation Example 2

Li₂CO₃, MoO₃, and TiO₂ were mixed as starting material in a molar ratio of 2.15:0.95:0.05 in metal powder forms. The mixture was heat-treated at 700° C. in a reducing atmosphere for 10 hours and cooled to obtain Li_{2.15}Mo_{0.95}Ti_{0.05}O₃. Then, the prepared Li_{2.5}Mo_{0.95}Ti_{0.05}O₃was heat-treated at 1100° C. in a reducing atmosphere for 10 hours. Then, an ethanol solution of 0.3 wt % Ti-isopropoxide was coated on the heat-treated Li_{2.05}Mo_{0.95}Ti_{0.05}O₃, and the resultant was heat-treated at 900° C. in a reducing atmosphere for 10 hours to prepare lithium titanium molybdate having a core-shell structure and coated with Li—Ti—O.

### Preparation Example 3

Lithium titanium molybdate having a core-shell structure was prepared in the same manner as in Preparation Example 2, except that Li_{2.15}Mo_{0.9}Ti_{0.1}O₃ was prepared by mixing Li₂CO₃, MoO₃, and TiO₂ as starting materials in a molar ratio of 2.15:0.9:0.1 in metal powder forms, and then a Li—TI—O coating layer is formed thereon.

### Preparation Example 4

Lithium titanium molybdate having a core-shell structure was prepared in the same manner as in Preparation Example 3, except that Li_{2.15}Mo_{0.8}Ti_{0.2}O₃ was prepared by mixing Li₂CO₃, MoO₃, and TiO₂ as starting materials in a molar ratio of 2.15:0.8:0.2 in metal powder forms, and then a Li—TI—O coating layer was formed thereon.

### Preparation Example 5

Lithium titanium molybdate having a core-shell structure was prepared in the same manner as in Preparation Example 3, except that Li_{2.15}Mo_{0.7}Ti_{0.3}O₃was prepared by mixing Li₂CO₃, MoO₃, and TiO₂ as starting materials in a molar ratio of 2.15:0.7:0.3 in metal powder forms, and then a Li—TI—O coating layer was formed thereon.

### Comparative Preparation Example 1

Li₂CO₃ and MoO₃ in powder forms were mixed as starting material in a molar ratio of 2:1. The mixture was heat-treated at 700° C. in a reducing atmosphere for 10 hours and cooled to obtain Li_{2.00}MoO₃. Then the cooled Li_{2.00}MoO₃ was heat-treated at 1100° C. in a reducing atmosphere for 10 hours to prepare lithium molybdenum oxide.

### Comparative Preparation Example 2

Li₂CO₃, MoO₃, and TiO₂ were mixed as starting materials in a molar ratio of 2.05:0.8:0.2 in metal powder forms. The mixture was heat-treated at 800° C. in a reducing atmosphere for 10 hours and cooled to obtain lithium titanium molybdate (Li_{2.05}Mo_{0.8}Ti_{0.2}O₃).

### Evaluation Example 1

### X-ray Diffraction Analysis

The active materials prepared according to Preparation Examples 1 to 5 and Comparative Preparation Examples 1 and 2 were subjected to X-ray diffraction analysis as follows.

A Scintag X-ray powder diffractometer model X'TRA equipped with a Cu-tube solid state detector was used (utilized), and a standard round aluminum sample holder with a rough zero background quartz plate having a cavity diameter of 25 mm and a depth of 0.5 mm was used (utilized).

Scanning parameters are as follows:

2θ range=2-80°

Scanning mode=Continuous scanning

Stepsize=3°/min

CuKα, λ=1.54056 Å

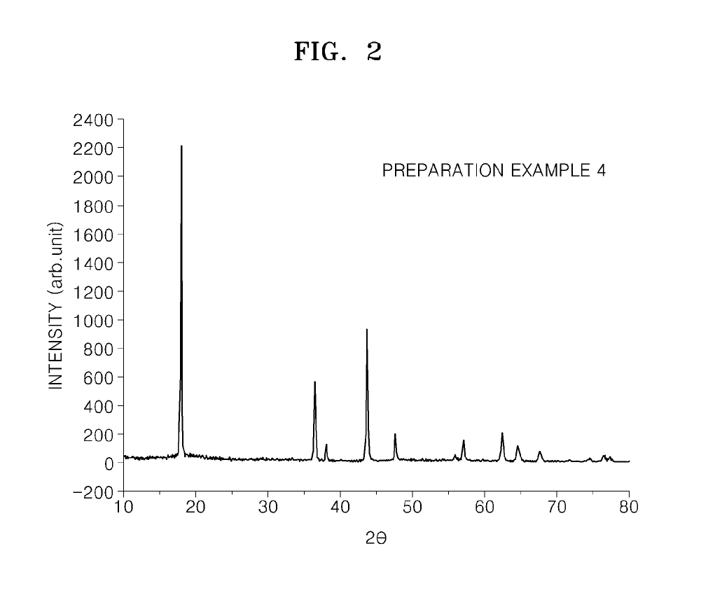

XRD analysis results of the active material prepared in Preparation Example 4 are illustrated in FIG. 2. As illustrated in FIG. 2, lithium titanium molybdate of Preparation Example 4 exhibits a first peak at a diffraction angle 2θ of 18°.

### Evaluation Example 2

### SEM Image Analysis

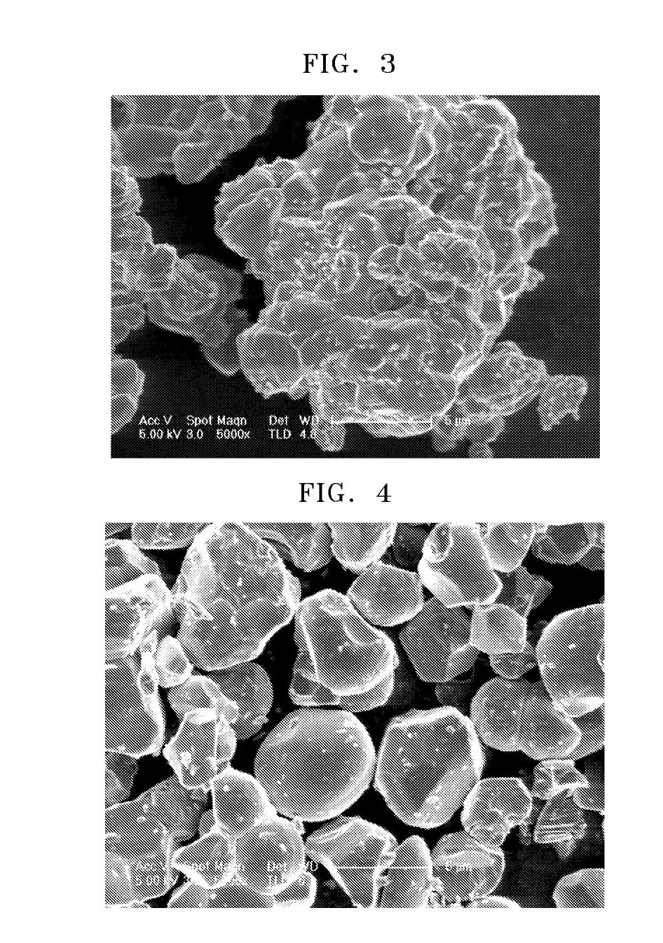

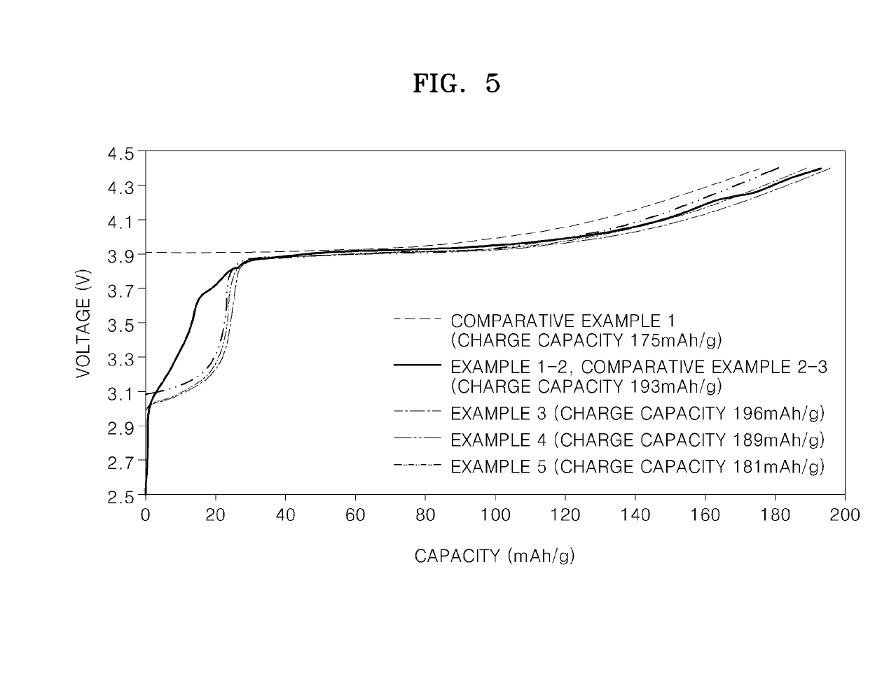

Lithium titanium molybdate prepared according to Preparation Example 1 and lithium molybdate prepared according to Comparative Preparation Example 1 were subjected to image analysis by using (utilizing) a scanning electron microscope (SEM). FIG. 3 illustrates an SEM image of lithium molybdate prepared in Comparative Preparation Example 1, and FIG. 4 is an SEM image of lithium titanium molybdate prepared in Preparation Example 1. Referring to FIG. 4, the lithium titanium molybdate of Preparation Example 1 has a Li—Ti—O coating layer on the surface, thereby exhibiting smooth morphology on the surface thereof.

### Preparation of Lithium Battery

### Example 1

A positive active material was prepared by mixing LiCoO₂ and lithium titanium molybdate prepared in Preparation Example 1 in a weight ratio of 80:20. The positive active material, polyvinylidene fluoride as a binder, and a carbon conductive agent were dispersed in a weight ratio of 96:2:2 in N-methylpyrrolidone (as a solvent) to prepare a positive electrode slurry. The positive electrode slurry was coated on an aluminum (Al)-foil to a thickness of 60 μm to prepare a thin plate. The thin plate was dried at 135° C. for 3 hours or more and pressed to prepare a positive electrode.

Lithium metal was used (utilized) as a counter electrode of the positive electrode. 1.5 M LiPF₆ was added to a mixture solvent of ethylene carbonate (EC), ethylmethyl carbonate (EMC), and dimethyl carbonate (DMC) in a volume ratio of 3:3:4 to prepare an electrolytic solution.

A separator formed of a porous polyethylene (PE) film was interposed between the positive electrode and the negative electrode to prepare a battery assembly, and the battery assembly was wound, pressed and accommodated in a battery case. Then, the electrolytic solution was injected into the battery case to prepare a lithium battery.

### Example 2

A lithium battery was prepared in the same manner as in Example 1, except that the positive active material was prepared by mixing LiCoO₂ and lithium titanium molybdate prepared in Preparation Example 2 in a weight ratio of 80:20.

### Example 3

A lithium battery was prepared in the same manner as in Example 1, except that the positive active material was prepared by mixing LiCoO₂ and lithium titanium molybdate prepared in Preparation Example 3 in a weight ratio of 80:20.

### Example 4

A lithium battery was prepared in the same manner as in Example 1, except that the positive active material was prepared by mixing LiCoO₂ and lithium titanium molybdate prepared in Preparation Example 4 in a weight ratio of 80:20.

### Example 5

A lithium battery was prepared in the same manner as in Example 1, except that the positive active material was prepared by mixing LiCoO₂ and lithium titanium molybdate prepared in Preparation Example 5 in a weight ratio of 80:20.

### Comparative Example 1

A lithium battery was prepared in the same manner as in Example 1, except that the positive active material was prepared by using (utilizing) only LiCoO₂.

### Comparative Example 2

A lithium battery was prepared in the same manner as in Example 1, except that the positive active material was prepared by mixing LiCoO₂ and lithium molybdenum oxide prepared in Preparation Example 1 in a weight ratio of 80:20.

### Comparative Example 3

A lithium battery was prepared in the same manner as in Example 1, except that the positive active material was prepared by mixing LiCoO₂ and lithium molybdenum oxide prepared in Preparation Example 2 in a weight ratio of 80:20.

### Evaluation Example 3

### Measurement of Charge Capacity

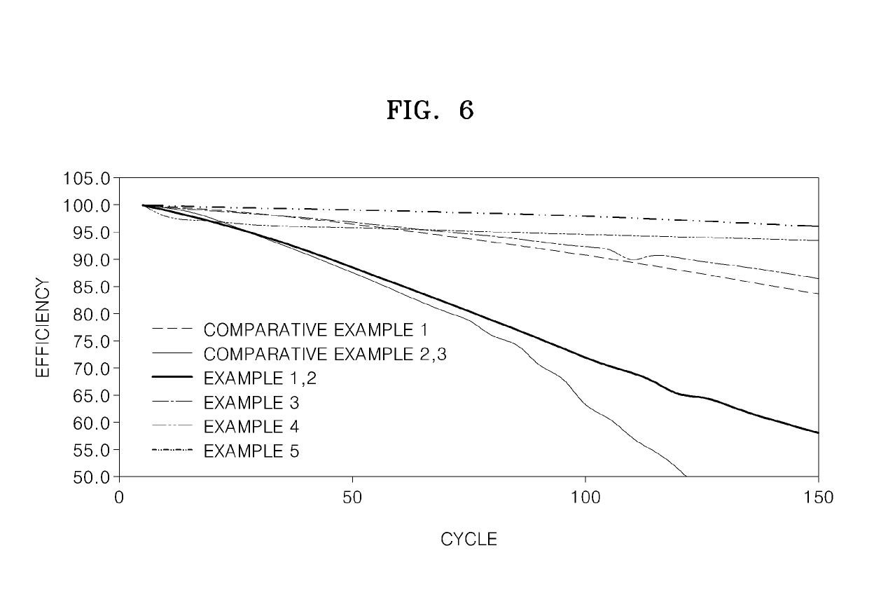

The lithium batteries prepared according to Examples 1 to 5 and Comparative Examples 1 to 3 were charged by flowing (applying) a current of 8 mA (0.05 C rate) per 1 g of the positive active material until a voltage reached 4.40 V (with respect to Li), and the current was cut-off. Charge capacities of the lithium batteries of Examples 1 to 6 and Comparative Examples 1 to 3 are shown in FIG. 5.

As illustrated in FIG. 5, the lithium batteries according to Examples 1 to 5 and Comparative Examples 1 to 3 have different charge capacities and different charge profiles according to the active material and the sacrificial positive electrode.

In addition, the lithium batteries according to Examples 1 and 2 have a charge capacity of 193 mAh/g, the lithium battery according to Example 3 has a charge capacity of 196 mAh/g, the lithium battery according to Example 4 has a charge capacity of 189 mAh/g, and the lithium battery according to Example 5 has a charge capacity of 181 mAh/g. It is confirmed that charge capacities of these lithium batteries are higher than that of commercially available lithium battery utilizing LiCoO₂ (Comparative Example 1), which has a charge capacity of 175 mAh/g. Meanwhile, the charge capacity of the lithium batteries according to Comparative Examples 2 and 3 are the same as those of the lithium batteries according to Examples 1 and 2 as 193 mAh/g. However, the lithium batteries according to Comparative Examples 2 and 3 are not suitable due to poor lifetime characteristics, which will be described later, since a large amount of Mo is eluted therefrom.

### Evaluation Example 4

### Evaluation of Lifetime Characteristics

The lithium batteries manufactured according to Examples 1 to 6 and Comparative Examples 1 and 2 were charged by flowing (applying) a current of 8 mA (0.05 C rate) per 1 g of the positive active material until the voltage thereof reached 4.0 V (with respect to Li) and then discharged at the same current flow rate until the voltage reached 2.0 V (with respect to Li). Then, the cycle of charging and discharging were repeated 150 times at the same flow rate of current to the same voltage. The charging and discharging were performed at 45° C. The capacity retention ratio (CRR) is defined as Equation 1 below.

Capacity retention ratio [%]=[Discharge capacity at each cycle/Discharge capacity at 1^{st} cycle]×100 Equation 1

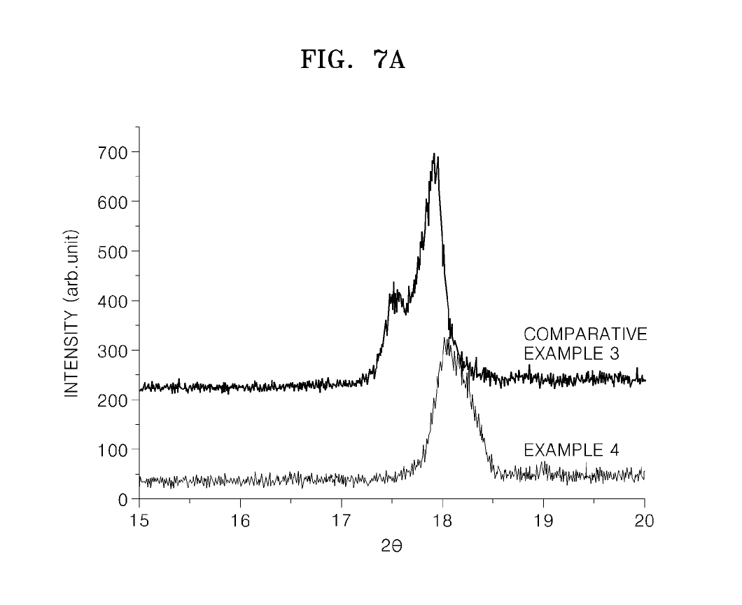

Evaluation results of charge retention ratios of the lithium batteries according to Examples 1 to 5 and Comparative Examples 1 to 3 are shown in FIG. 6.

As illustrated in FIG. 6, the lithium batteries according to Examples 3 to 5 have longer lifetime than that according to Comparative Example 1. Here, the lithium battery according to Example 1 has shorter lifetime than that of Comparative Example 1 due to a low amount of residual Li, and the lithium battery according to Example 2 has a relatively shorter lifetime since Mo having an unstable structure is eluted due to a low amount of substituted Ti. The lithium battery according to Comparative Example 2 in which Mo is not substituted with TI and the lithium battery according to Comparative Example 3, which does not have the Li—Ti—O coating layer, exhibit relatively the shortest lifetime.

### Evaluation Example 5

### X-ray Diffraction Analysis of Positive Electrode Plate after Charging

The lithium batteries according to Example 4 and Comparative Example 3 were charged under the conditions of 4.4 V-0.05 CC (1C=160 mAh/g, LL=20).

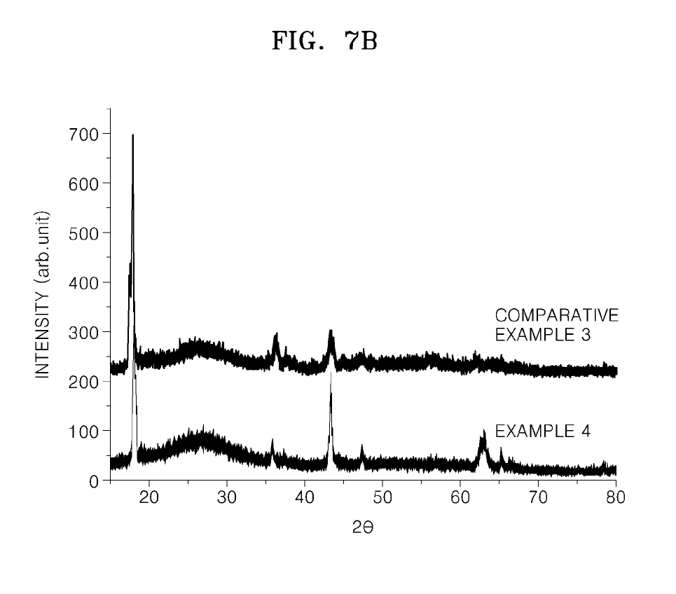

Samples were collected from the positive electrode plates by dissembling the charged lithium batteries and respectively subjected to X-ray diffraction analysis using (utilizing) CuKα rays in the same manner as in Evaluation Example 1. XRD analysis results of the lithium batteries according to Example 4 and Comparative Example 3 are illustrated in FIGS. 7A and 7B.

Referring to FIGS. 7A and 7B, it is confirmed that lithium titanium molybdate according to Example 4 and lithium titanium molybdate according to Comparative Example 3 exhibit different XRD peaks after charging.

As described above, according to the one or more of the above embodiments, the positive active material may increase charge capacity of the lithium battery and may improve lifetime characteristics of the lithium battery.

It should be understood that the example embodiments described herein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention, as defined by the following claims and equivalents thereof.

What is claimed is:

1. A positive active material comprising:
a lithium-transition metal composite oxide; and
lithium titanium molybdate represented by Formula 1 below:
LiₐMo₁₋ₓTiₓO_{b} Formula 1
wherein 0.1≦a≦2.3, 0<x≦0.3, and 2.8≦b≦3.2.

2. The positive active material of claim 2, wherein the lithium titanium molybdate is a sacrificial positive electrode.

3. The positive active material of claim 1, wherein the lithium titanium molybdate is in an amorphous MoO₃form after a formation process.

4. The positive active material of claim 1, wherein 2.1≦a≦2.3.

5. The positive active material of claim 1, wherein 0.1≦x≦0.3.

6. The positive active material of claim 1, wherein the lithium titanium molybdate comprises, on the surface thereof, a metal compound-containing coating layer comprising at least one element selected from the group consisting of sodium (Na), potassium (K), cesium (Cs), magnesium (Mg), calcium (Ca), strontium (Sr), barium (Ba), yttrium (Y), lanthanum (La), titanium (Ti), zirconium (Zr), vanadium (V), manganese (Mn), iron (Fe), cobalt (Co), nickel (Ni), silver (Ag), gold (Au), zinc (Zn), and aluminum (Al).

7. The positive active material of claim 6, wherein the metal compound comprises a metal oxide, a Li-containing metal oxide, a metal alkoxide, or any combination thereof.

8. The positive active material of claim 1, wherein the lithium titanium molybdate exhibits a first peak at a diffraction angle 2θ of 18.00±0.05° as a result of X-ray diffraction analysis utilizing CuKα rays.

9. The positive active material of claim 1, wherein the lithium titanium molybdate exhibits a first peak and a second peak at diffraction angles 2θ of 18.00±0.05° and 43.6±0.1°, respectively, as a result of X-ray diffraction analysis utilizing CuKα rays, and a peak intensity ratio of the first peak to the second peak I₁/I₂ is about 1.2 to about 2.5.

10. The positive active material of claim 1, wherein the lithium-transition metal composite oxide comprises at least one compound selected from the group consisting of LiCoO₂; LiNiO₂; LiMnO₂; LiMn₂O₄; Li(Niₐ₁Co_{b1}Mn_{c1})O₂, where 0<a1<1, 0<b1<1, 0<c1<1, and a1+b1+c1=1; LiNi_{i-Y}Co_{Y}O₂, LiCo_{1-Y}Mn_{Y}O₂, LiNi_{1-Y}Mn_{Y}O₂, where 0≦Y<1; Li(Niₐ₂Co_{b2}Mn_{c2})O₄, where 0<a2<2, 0<b2<2, 0<c2<2, and a2+b2+c2=2; LiMn_{2-z}Ni_{z}O₄, LiMn_{2-z}Co_{z}O₄, where 0<Z<2; LiCoPO₄; LiFePO₄; LiFePO₄; V₂O₅; TiS; and MoS.

11. The positive active material of claim 1, wherein a weight ratio of the lithium-transition metal composite oxide to the lithium titanium molybdate is about 50:50 to about 99:1.

12. A positive active material comprising:
lithium titanium molybdate exhibiting a first peak at a diffraction angle 2θ of 18.00±0.05° as a result of X-ray diffraction analysis utilizing CuKα rays.

13. The positive active material of claim 12, wherein the lithium titanium molybdate exhibits a second peak at a diffraction angle 2θ of 43.6±0.1° as a result of X-ray diffraction analysis utilizing CuKα, and a peak intensity ratio of the first peak to the second peak I₁/I₂ is about 1.2 to about 2.5.

14. The positive active material of claim 12, wherein the lithium titanium molybdate is represented by Formula 1 below:
LiₐMo₁₋ₓTiₓO_{b} Formula 1
wherein 0.1≦a≦2.3, 0<x≦0.3, and 2.8≦b≦3.2.

15. The positive active material of claim 12, wherein the lithium titanium molybdate comprises, on the surface thereof, a metal compound-containing coating layer comprising at least one element selected from the group consisting of sodium (Na), potassium (K), cesium (Cs), magnesium (Mg), calcium (Ca), strontium (Sr), barium (Ba), yttrium (Y), lanthanum (La), titanium (Ti), zirconium (Zr), vanadium (V), manganese (Mn), iron (Fe), cobalt (Co), nickel (Ni), silver (Ag), gold (Au), zinc (Zn), and aluminum (Al).

16. The positive active material of claim 15, wherein the metal compound comprises a metal oxide, a Li-containing metal oxide, a metal alkoxide, or any combination thereof.

17. The positive active material of claim 12, further comprising a lithium-transition metal composite oxide selected from the group consisting of LiCoO₂; LiNiO₂; LiMnO₂; LiMn₂O₄; Li(Niₐ₁Co_{b1}Mn_{c1})O₂, where 0<a1<1, 0<b1<1, 0<c1<1, and a1+b1+c1=1; LiNi_{1-Y}Co_{Y}O₂, LiCo_{1-Y}Mn_{Y}O₂, LiNi_{1-Y}Mn_{Y}O₂, where 0≦Y<1; Li(Niₐ₂Co_{b2}Mn_{c2})O₄, where 0<a2<2, 0<b2<2, 0<c2<2, and a2+b2+c2=2; LiMn_{2-z}Ni_{z}O₄, LiMn_{2-z}Co_{z}O₄, where 0<Z<2; LiCoPO₄; LiFePO₄; LiFePO₄; V₂O₅; TiS; and MoS.

18. The positive active material of claim 17, wherein a weight ratio of the lithium-transition metal composite oxide to the lithium titanium molybdate is about 50:50 to about 99:1.

19. The positive active material of claim 12, wherein the lithium titanium molybdate is a sacrificial positive electrode.

20. A lithium battery comprising:
a positive electrode comprising the positive active material according to claim 1;
a negative electrode facing the positive electrode; and
an electrolyte between the positive electrode and the negative electrode.
